(19) United States
(12) Patent Application Publication
(10) Pub. No.: US 2012/0199076 A1
(43) Pub. Date: Aug. 9, 2012

(54) AUTOMATED FEEDING STATION FOR IN-HOUSE COMPANION ANIMAL TESTING

(75) Inventors: Stanley Leo Biede, Topeka, KS (US); Scott Lyman Mickelsen, Topeka, KS (US); Sutyajeet I. Soneja, Baltimore, MD (US); James P. Stadler, Silver Lake, KS (US)

(73) Assignee: Hill's Pet Nutrition, Inc., Topeka, KS (US)

(21) Appl. No.: 13/022,179

(22) Filed: Feb. 7, 2011

(51) Int. Cl. A01K 5/00

(52) U.S. Cl. 119/51.02

(57) ABSTRACT

An automated feeding station for in-home testing away from unfamiliar laboratory settings test the acceptance of pet food by monitoring the reaction of the companion animals or pets in their comfortable in-home environment where the animals make their preferred choice of food without distractions caused by an unfamiliar environment. A pet owner scans appropriate food identifiers to verify the proper diet is being distributed into the appropriate food-receiving region(s). Once the food bowls are placed in appropriate food receiving regions within the feeding station, the testing system begins collecting data and transmits this data, preferably wirelessly, to the testing investigators. The preferred feeding station can measure: intake for the companion animal, information pertaining to the rate of food consumption, the animal's first approach to food, and the food first tasted by the animal. This information is provided via appropriate sensors and algorithms designed for this purpose within the system.

### FIELD OF THE INVENTION

The present invention relates generally to animal testing protocols, and more specifically, to feeding stations used in home for testing animal feeding activity.

### BACKGROUND OF THE INVENTION

Understanding a pet's acceptance of foods is of paramount importance in the development of foods for companion animals. Current testing protocols rely heavily on the animal's resources available at a pet nutrition testing center and similar laboratory sites. One example of a testing protocol for monitoring the feeding of animals is disclosed in U.S. Patent Publication No. US 2007/0181068 to McKeown. McKeown teaches a system for automatically feeding animals using identifiers on the animals and controlled access to one or more food sources based on the particular animals seeking food in the laboratory like controlled setting.

While the panels are consistently monitored to ensure validity of the data, the use of pets or companion animals (e.g., single and mixed breeds of animals, such as cats, dogs, mice, gerbils, rabbits, muskrats, birds, iguana, hermit crabs) in essentially a laboratory setting brings to consideration the problem of correlating the testing data derived from a laboratory setting into an actual home setting for the animal.

Studies which have been conducted to determine effectiveness and reactions of foods using in-home testing protocols have met with some success and provide data from real life settings. However, the studies have identified several issues that make the in-home testing somewhat burdensome. Issues identified included the time involved with sample preparation, pet owners following strict protocols, sample weighing and data collection. Thus, it would be beneficial to provide an automated feeding system for in-home testing that reduces the amount of time required by the study investigators and pet owners to prepare samples for each pet enrolled in the study within an environment most comfortable for the companion animal.

### BRIEF SUMMARY OF THE INVENTION

The present invention pertains to an automated feeding station for in-home testing. The automated feeding station reduces the amount of time required to prepare samples for each pet enrolled in a study, especially in a daily feeding routine. The automated feeding station also provides real-time monitoring of the study to help ensure that study protocols are followed and for timely data collection preferably through the use of phone or high-speed interne connections. The automated feeding station of the preferred embodiments minimizes human transcription error, automatically records intake for a tested animal over a specified study period and provides in-home collection of information pertaining to predefined occurrences between the companion animal and the feeding station. Examples of such occurrences include the food receiving region first approached by the animal, the food first tasted by the animal, the amount of food consumed from each food receiving region and the rate at which the food in each region was consumed.

In accordance with an example of the preferred embodiments, the invention includes a system for testing food provided to a companion animal by a person in a non-laboratory setting wherein a predetermined diet plan is provided to the person for the companion animal. The exemplary system includes a plurality of food containers with each of the containers holding a respective animal food therein and bearing a machine readable tag, a feeding station at the non-laboratory setting, and a remote host computer. The feeding station includes a plurality of respective food receiving regions, a scanner, a sensor system, and a computer processor. The scanner is arranged for scanning the tags and for providing tag information signals regarding the food in the scanned container. The sensor system is arranged for providing food information signals. The computer processor is arranged for receiving the tag information signals to determine if the container(s) hold(s) the correct food(s) for the predetermined diet plan based on the scanning of the tags and providing an output signal to the person indicative thereof. The computer processor is also arranged for receiving the tag information signals and the food information signals for determining and providing output data signals. The remote host computer is arranged for receipt of the output data signals.

In accordance with another example of the preferred embodiments, the invention includes a method for testing food provided to a companion animal by a person in a non-laboratory setting. The method includes the steps of providing the person with a predetermined diet plan for the companion animal, providing the person with an automated feeding system arranged to be accessed by the companion animal with the automated feeing system including respective food-receiving regions, providing containers holding the food to be tested with each of the containers bearing a machine readable tag, scanning the tags on the containers to determine if the containers hold the correct foods for the predetermined diet plan, placing the food from the scanned containers in respective food receiving regions at the non-laboratory setting, automatically collecting data relating to a predetermined interaction between the companion animal and the accessed feeding station, and transmitting the collected data to a remote host computer.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

The invention will be illustrated with reference to the attached drawings, in which like reference numbers designate like features, and wherein:

FIG. 1 is a perspective view of a feeding station in accordance with the preferred embodiments of the invention;

FIG. 2 is a top plan view of the feeding station of FIG. 1;

FIG. 3 is a sectional view taken along line of FIG. 2;

FIG. 4 is a perspective view of a food container in accordance with a preferred embodiment of the invention; and

FIG. 5 is a flow chart depicting the operation of the feeding station system of the preferred embodiments.

### DETAILED DESCRIPTION OF THE INVENTION

The following description of the preferred embodiment(s) is merely exemplary in nature and is in no way intended to limit the invention, its application, or uses.

As used throughout, ranges are used as a shorthand for describing each and every value that is within the range. Any value within the range can be selected as the terminus of the range. In addition, all references cited herein are hereby incorporated by reference in their entireties. In the event of a conflict in a definition in the present disclosure and that of a cited reference, the present disclosure controls.

Unless otherwise specified, all amounts, quantities, and geometric features expressed herein and elsewhere in the specification should be understood to include substantial approximations of the express term. For example, the term “horizontal” should be understood as including generally or approximately horizontal to the ground surface.

Prior to initiating an in-home companion animal food testing, a pet owner would need to scan appropriate food identifiers (e.g., barcode labels, RFID tags) and verify the proper diet is being distributed into the appropriate food-receiving region(s) (food bowl, food container). The proper diet for the tasting is determined by the test that has been scheduled and assigned by food acceptance testing investigators. Once the test is activated and the food bowls are placed in appropriate food receiving regions within the feeding station, the testing system begins collecting data and transmits this data to the testing investigators, preferably over phone or Internet connections. In addition to the exemplary feeding station having the capability to measure intake for the companion, the feeding system is also able to measure information pertaining to the rate of food consumption, the animal's first approach to food, and the food first tasted by the animal. This information is provided via appropriate sensors and algorithms specially designed for this purpose within the system. Once the test is completed, the owner should empty the bowls, refill the bowls and restart or continue the study according to the assigned test protocol.

The invention is further described in the following examples. The examples are merely illustrative and do not in any way limit the scope of the invention as described and claimed.

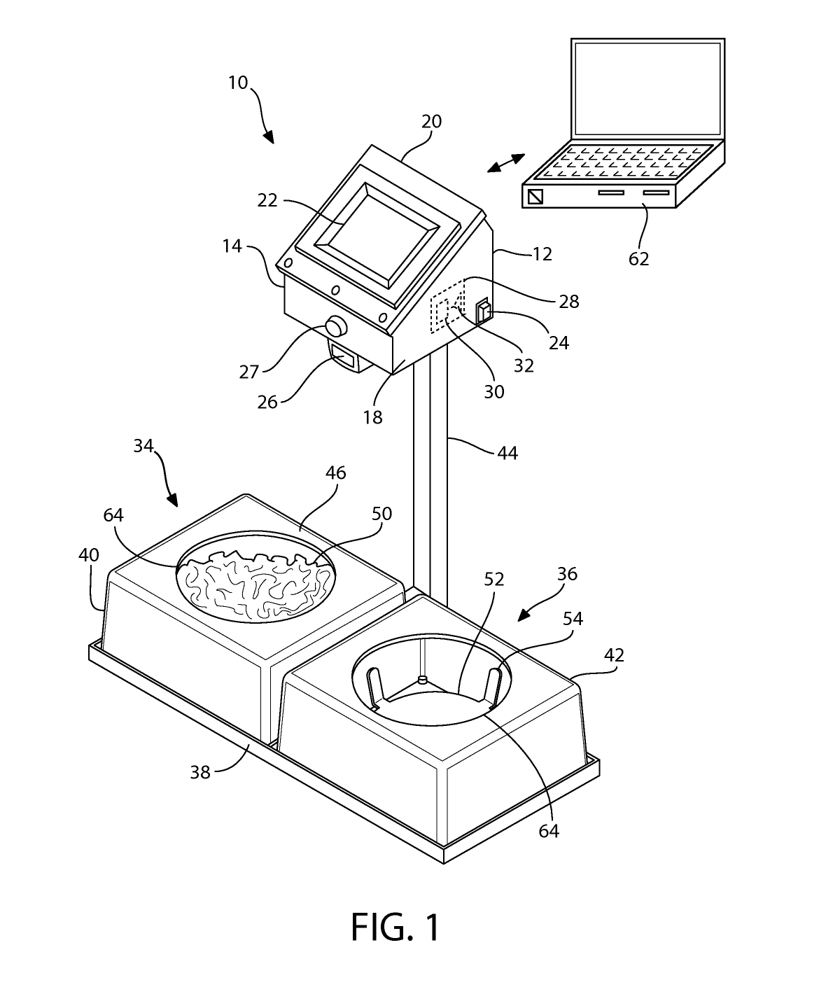

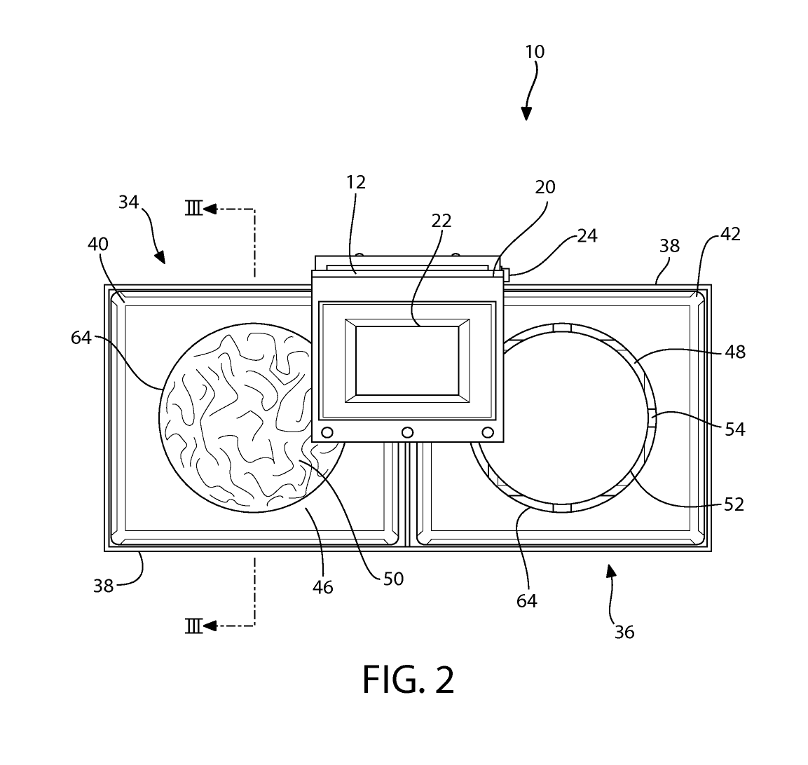

Referring now to the drawings, wherein like reference numbers refer to like parts, there is shown at FIGS. 1 and 2 an exemplary embodiment of an automated system with a feeding station 10 for a companion animal in a non-laboratory home setting having a main housing 12 including a front panel 14, side panels 16 (not shown), 18, and a top panel 20 with a user interface 22. The housing is preferably made of a metal or rigid plastic (e.g., Plexiglas) or other suitable materials. Warning lights or alarms may be employed to determine if a feeding source is empty or if the system is not functioning properly as understood by a skilled artisan. Such alarms may also be provided to the in-home user via the user interface 22, which includes a display for communicating with the user. The user interface may also provide testing instructions and direction to the user for running the test. The side panel 18 includes a USB port 24.

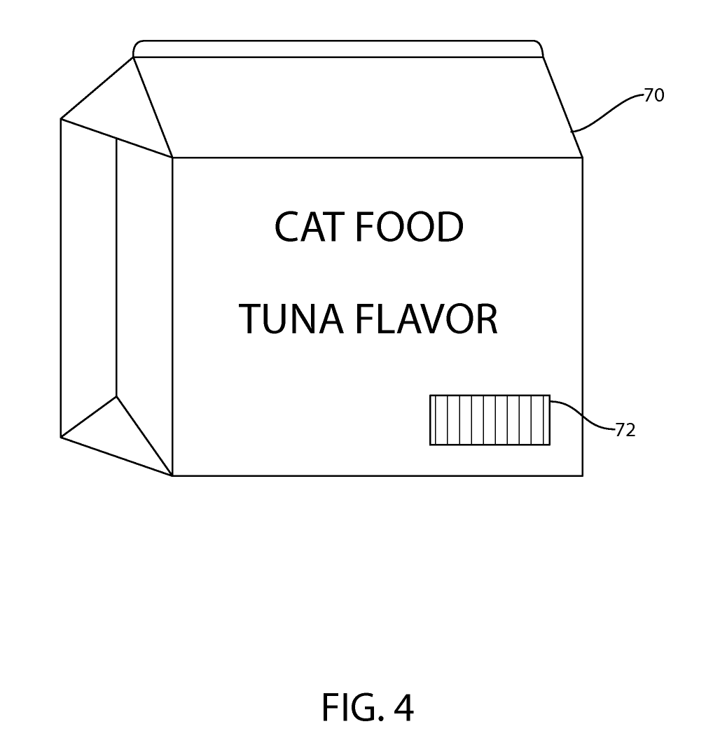

Referring to FIG. 1, the feeding station 10 includes a scanner 26, a sensor system and a computer processor 28 having a micro-controller 30 and a transceiver 32 conductively coupled to the micro-controller. The scanner and computer processor are preferably embedded within the housing 12, with the scanner 26 including a window for access to scan tags identifying a food product (FIG. 4). The scanner 26 is located at the bottom of the housing 12 and is connected to the computer processor 28, which includes the programmable micro-controller 30. The scanner, which can also be described as a tag, bar code, digital code or RFID reader, is used to identify the identity of foods held within food containers or bowls 46 provided by the animal food study investigators. A scanner switch 27 located on the front panel 14 above the scanner 26 turns the scanner on for a limited amount of time (e.g., two minutes, 5 minutes, 30 seconds). Since the scanner 26 is operable to scan the food products being tested, the scanner does not need to be on during the test period. Accordingly, when turned on by the scanner switch 27, the scanner remains on for a limited time to scan the food products, and then goes dormant.

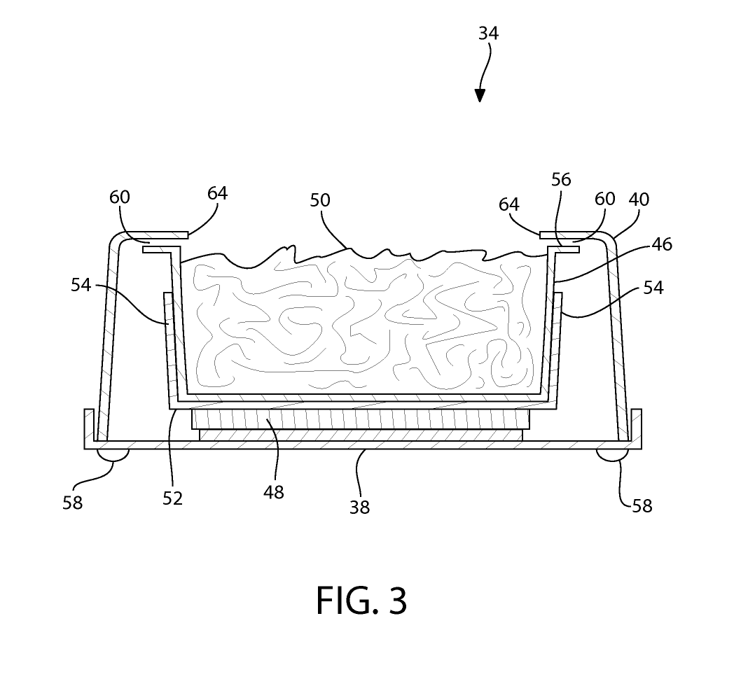

The feeding station 10 includes a plurality (e.g., two) of food receiving regions 34, 36 with each region arranged for receiving one of the respective animal foods 50 used during the test period. Each food receiving region includes a respective bowl cover 40, 42 that holds the respective food within. As can best be seen in FIGS. 1 and 3, the bowl covers 40, 42 sit on a bottom support 38 that includes a perpendicular flange about the support to restrict lateral movement by the bowl covers. The bottom support 38 and housing 12 form an integral structural unit with the bottom support attached to the housing via a square column 44. Floor pads 58 are attached to the lower surface of the bottom support 38 for contact with the floor. The pads 58 are preferably formed of a rubber or plastic material and provide a non-marking slip-free and stable footprint on the floor. The pads are adhesively coupled to the bottom support, but alternatively be attached to the bottom support via threaded or frictional engagement.

The bowl covers 40, 42 are each shown as a generally quadrilateral prism hollowed out and including a top side defining an aperture 64 for the animal to access the food 50 through the bowl covers. It is understood that the shape of the bowl covers is not limited to any one shape. It is important that the bowl covers are shaped to house food 50 for the tested animal to reach and consume easily through the top side aperture 64 of the bowl covers. While the food 50 may be applied directly into each aperture, it is preferred that each food receiving region also include a food bowl 46, which is a container configured to fit within each respective bowl cover, as can best be seen by example in FIGS. 1 and 3.

The food bowls 46 may come pre-filled and packaged for use in the companion animal test. Preferably, however, pre-weighed and sealed bags of food are provided so that a pre-determined amount of food can be dispensed into the bowl 46. This minimizes human transcription error and in-home testing error since the food put into the bowls is pre-weighed and sealed according to the testing protocol and requirements of the testing investigators, and thus not subject to inconsistencies inherent from someone at the house measuring the required amount of food and filling the bowl. The food bowl 46 terminates at an upper rim 56 thereof extending around the opening of the bowl. The food bowl may be sealed about its upper rim in embodiments of the invention having pre-filled bowls. This sealing is to keep the pre-filled food 50 fresh in the bowl 46 before the food is placed in the bowl cover 40, 42 for consumption, as readily understood by a skilled artisan, for example with a plastic and/or foil removable lid (not shown) thermally or adhesively sealed to a rim 56 of the bowl. In embodiments where pre-filled bags are provided, the material and sealing of the bags are as generally used in packaging pet food.

As part of the sensor system, each food receiving region includes a scale 48 for weighing food placed in the food bowl 46. For example, the scale 48 can be seen in FIG. 3 as a sensor located at the bottom 50 of the bowl cover 40 in abutment with the food bowl 46 placed into the bowl cover 40. In this configuration, the scale 48 can constantly monitor the weight of the food bowl 46 and any food placed therein for the test or study, and forwards that information to the computer processor 28 via wired or wireless connection.

Still referring to FIGS. 1 and 3, each food receiving region also preferably includes a bowl support unit 52 for helping to hold a food bowl 46 on the scale 48. The bowl support unit 52 includes fingers 54 that extend upwards nearly vertical from the bowl support unit placed generally horizontally to hold the food bowl 46 within. The bowl support unit is preferably made of a hard and slightly resilient plastic, metal or fibrous material to hold the food bowl in place even when the companion animal pushes the bowl while eating. It should be noted that the food bowl 46 sits on the support unit 52 on the scale.

It can also be seen that the food bowl 46 is shown within and separate from the bowl cover 40, which protects the food bowl from contact by the companion animal. In particular, the food bowl extends to its upper rim 56 that when placed for testing does not touch the bowl cover 40 and preferably remains below the top side of the bowl cover. A small gap 60 of preferably about one-quarter inch is preserved between the upper rim 56 and the bowl cover to avoid the transfer of any weight of the food bowl 46 onto the bowl cover, which might affect the effectiveness of the scale 48 in measuring the weight of the food. The fingers 54 of the support unit 52 keep the food bowl free standing and centered within the bowl cover to ensure that the scale 48 measures the correct weight of the food 50 and not a weight affected by contact between the food bowl 46 and the bowl cover.

Still referring to FIG. 3, the aperture 64 of the bowl cover has an inside diameter smaller (e.g., between one-quarter inch and one inch, about one-half inch) than an inside diameter of the opening at the top of the food bowl 46. This geometry helps ensure accurate food intake measurements by keeping the companion animal's body parts from touching the scale. In addition, the bowl cover/bowl diameter relationship helps to keep dropped food in the bowl or on top of the bowl cover so that the food is accessible to the tested animal.

Referring back to FIG. 1, the computer processor 28 is connected to the scanner 26 and sensors (e.g., scales 48) preferably via direct wire connection, and is also in communication with a remote computer 62 preferably via wireless connection. The processor 28 includes a memory to record many variables, for example, the time of a feeding, which food receiving region the animal first approached, which region the animal first consumed food from, how much food of each type was consumed, and the rate of food consumption. The computer processor 28 includes a transceiver 32 or modem so that it can communicate with the remote computer 62 for remote monitoring and updates to the feeding program of the companion animal being fed by the feeding station 10. The processor 28 can also monitor the number and frequency of feedings within a given time period and can allow or prevent further access to the food in the food receiving regions in accordance with the testing guidelines.

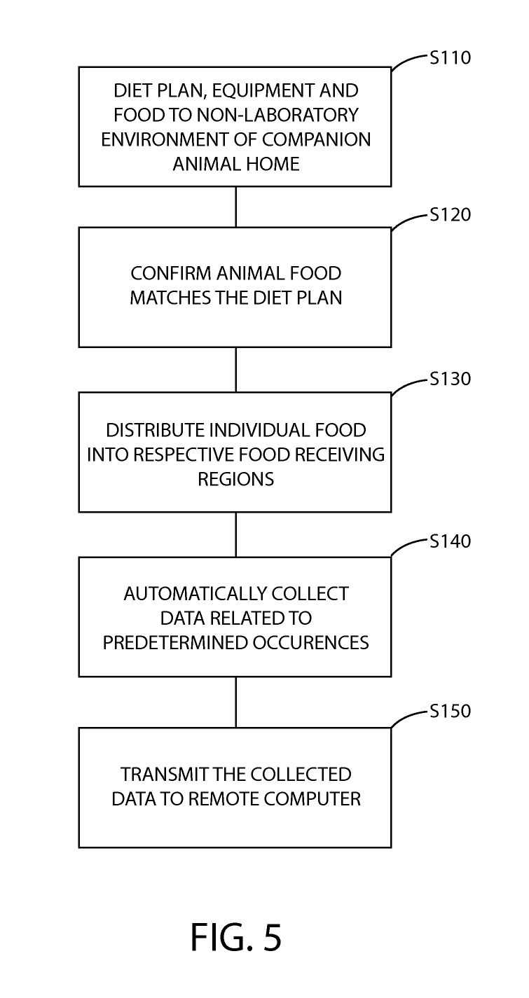

FIG. 5 depicts a flow diagram of an exemplary testing of a companion animal in a non-laboratory environment. Initially, at step S110, a diet plan provided by testing personnel, equipment, including the feeding station 10, and food are provided to the non-laboratory environment of the companion animal home. Each food type is stored in a respective container 70 (e.g., sealed bag, sealed plastic or aluminum container/bowl) as can be seen for example in FIG. 4. Each of the containers 70 bears a machine readable tag, for example, a UPC coded tag or RFID tag. The tags, which identify the food stored in the container 70 are read by the scanner 26, which is shown as integral with the housing, but can also be separate from the housing yet in communication with the processor 28, for example, as a hand-held device.

Once the system confirms that the food matches the diet plan at step S120, the food is placed from the scanned containers into respective ones of the food receiving regions 34, 36 at step S130. While the system operates automatically, the feed sources are preferably filled manually. While not being limited to a particular theory, food containers from the testing personnel are preferably sized as the food bowls 46 so that they can be directly placed onto the respective bowl covers. This approach further minimizes human error and simplifies the step of placing the food into the food receiving regions. As discussed above, such containers if shaped as food bowls 46 are provided to the pet owner with the food sealed within the container by a lid or cover that is removable prior to placement of the container in the respective bowl cover of the food receiving region. In order to place the food into the respective food receiving region at step S130, a testing person removes the bowl cover 40, 42 from the bottom support 38 of the food receiving region 34, 36 to gain access into the food receiving region, and removes any lid from the food bowl. Then, the person places a food containing food bowl 46 onto the support unit 52 within the fingers 54, and places the respective bowl cover over the food bowl and back onto the bottom support 38, with the food 50 accessible through the aperture 64 of the bowl cover.

Next, the sensors/scales 48 and computer processor 28 monitor the different food types placed into the different food receiving regions 34, 36 as discussed above for interactions or occurrences between the companion animal and the feeding station 10. Based on the actions of the animal, the computer processor 28 automatically collects the data relating to any of the predetermined occurrences at step S140 and transmits the collected data to the remote computer 62 in real time or at predetermined time intervals as set forth by the testing personnel or in-home person conducting the testing at step S150. A modem, LAN, phone or other communication device can be used to allow the system to be remotely configured and controlled by the remote computer 62.

The system of the present invention can be used to test the acceptance of newly created food mixtures or types of food by monitoring the reaction of the companion animals or pets in their comfortable in-home environment. In other words, the animals themselves can make their preferred choice of food without new distractions caused by an unfamiliar environment.

While the invention has been described in detail and with reference to specific examples thereof, it would be apparent to one skilled in the art that various changes and modification can be made therein without departing from the spirit and scope thereof. For example, the scanner 26 may be integral with the housing or separate as a hand-held scanner. Moreover, the support unit could be attached to the bowl cover 40, 42 with fingers 54 extending downwards from the cover to hold the food bowl 46 in place. Further, the remote computer may be located at the location of the in-home testing or a location of testing personnel. Without further elaboration, the foregoing will so fully illustrate the invention that others may, by applying current or future knowledge, readily adapt the same for use under various conditions of service.

As used throughout, ranges are used as shorthand for describing each and every value that is within the range. Any value within the range can be selected as the terminus of the range. In addition, all references cited herein are hereby incorporated by referenced in their entireties. In the event of a conflict in a definition in the present disclosure and that of a cited reference, the present disclosure controls.

What is claimed is:

1. A system for testing food provided to a companion animal in a non-laboratory setting wherein a predetermined diet plan is provided for the companion animal, said system comprising:
a plurality of food containers, each of said containers holding a respective animal food therein and bearing a machine readable tag thereon;
a feeding station at the non-laboratory setting including a plurality of respective food-receiving regions, a scanner, a sensor system, and a computer processor, said scanner being arranged for scanning said tags and for providing tag information signals regarding the food in the containers, said sensor system being arranged for providing food information signals, said computer processor being arranged for receiving said tag information signals to determine if said container(s) hold(s) the correct food(s) for the predetermined diet plan based on the scanning of said tags and providing an output signal to the person indicative thereof, said computer processor also being arranged for receiving said tag information signals and said food information signals for determining and providing output data signals relating to a predetermined interaction between the companion animal and the feeding station at the non-laboratory setting; and
a remote host computer arranged for receipt of said output data signals.

2. The system of claim 1, said predetermined interaction being at least one of the following occurrences: which food receiving region was first approached by the companion animal, which food was first tasted by the companion animal, the amount of food consumed from each food-receiving region and the rate at which the food in each food-receiving region was consumed.

3. The system of claim 1, wherein said output signals are provided to said remote host computer via a telephone line or the Internet.

4. The system of claim 1, wherein said tags comprise bar codes.

5. The system of claim 1, wherein said food-receiving regions are arranged to be automatically exposed to provide the companion animal with access to them.

6. The system of claim 1, said sensor system including a scale placed in each of said food-receiving regions, each said food-receiving regions including a bowl cover housing said scale and one of said food containers on said scale, said scale adapted to measure the animal food in said food container, said bowl cover having a top side defining an aperture for access to the animal food.

7. The system of claim 6, said food-receiving region further including a support unit that holds said food container within the bowl cover.

8. The system of claim 7, said support unit being located adjacent said scale and holding said food container free-standing on said scale.

9. The system of claim 8, wherein said support unit sits on said scale and includes fingers that abut and hold said food container.

10. The system of claim 6, wherein said food container has an upper rim that is lower than the top side of the bowl cover, said food container further having an opening that is larger than said aperture in said bowl cover.

11. A method for testing food provided to a companion animal by a person in a non-laboratory setting comprising:
a) providing the person with a predetermined diet plan for the companion animal;
b) providing the person with an automated feeding station arranged to be accessed by the companion animal, said automated feeding station including respective food-receiving regions;
c) providing containers holding the food to be tested, each of said containers bearing a machine readable tag;
d) scanning said tags on said containers to determine if said container(s) hold(s) the correct food(s) for the predetermined diet plan, and if so;
e) placing the food from said container(s) in respective ones of said food-receiving regions at the non-laboratory setting;
f) automatically collecting data relating to a predetermined interaction between the companion animal and the accessed feeding station at the non-laboratory setting; and
g) transmitting the collected data to a remote host computer.

12. The method of claim 11, wherein the step f) automatically collects data related to the predetermined interaction of at least one of the following occurrences: which food receiving region was first approached by the companion animal, which food was first tasted by the companion animal, the amount of food consumed from each food-receiving region and the rate at which the food in each food-receiving region was consumed.

13. The method of claim 11, wherein said collected data is transmitted to the remote host computer via a telephone line or the Internet.

14. The method of claim 11, wherein said tags comprise bar codes.

15. The method of claim 11, wherein said food-receiving regions are automatically exposed to provide the companion animal with access to them.

16. The method of claim 11, wherein said remote host computer is used by an animal food manufacturer to evaluate the collected data to help formulate companion animal food products.

17. The method of claim 11, each automated feeding station including a scale housed within a bowl cover, said step (e) including removing the bowl cover from the food receiving region, placing a food container with food on the scale, and placing the bowl cover over the food bowl and the scale.
